(19) United States
(12) Patent Application Publication
(10) Pub. No.: US 2024/0278390 A1
(43) Pub. Date: Aug. 22, 2024

(54) HAND TOOL WITH RADIALLY FLEXIBLE DRIVE GEAR

(71) Applicant: Stanley Black & Decker, Inc., New Britain, CT (US)

(72) Inventors: Marguerite McCarthy, Houston, TX (US); Pavel Dugin, Catonsville, MD (US); Derek Anthony Marchanti, Baltimore, MD (US)

(21) Appl. No.: 18/443,978

(22) Filed: Feb. 16, 2024

Related U.S. Application Data
(60) Provisional application No. 63/446,430, filed on Feb. 17, 2023.

(51) Int. Cl. B25B 13/46; B25B 13/04; B25B 13/08

(52) U.S. Cl. CPC B25B 13/463; B25B 13/04; B25B 13/08

(57) ABSTRACT

A hand tool having an elongated handle, an elastically flexible drive gear, a plurality of roller members, and a cage member. The elongated handle has an interior annular wall that defines a cavity that supports the drive gear rotatably for movement between a radially compressed position and a radially decompressed position. The drive gear includes an inner periphery configured to engage a fastener, and an outer periphery containing circumferentially spaced pockets to receive a corresponding roller member. The cage member is supported in the cavity to support the drive gear in a manner that facilitates movement of the roller members to cause movement of the drive gear to the radially compressed position to apply a torquing force on the fastener in response to selective rotation of the handle in a first direction. The hand tool may thus be operated as a normal gear ratchet wrench under traditional load conditions.

### CROSS-REFERENCE TO RELATED APPLICATION

This is a non-provisional application claiming priority to U.S. Provisional Patent Application No. 63/446,430, filed on Feb. 17, 2023, which is hereby incorporated by reference in its complete entirety.

### TECHNICAL FIELD

The present disclosure relates generally to hand tools, and more particularly, to hand-held ratchet wrenches having adjustable openings.

### BACKGROUND

Ratchet wrenches are generally known in the art. For example, U.S. Pat. No. 8,904,907 describes a reversible force or torque transfer device that may be used in many different applications. The example used for illustrative purposes of this patent is a wrench. The wrench of U.S. Pat. No. 8,904,907 employees a reverse mechanism that can resist any amount (up to the shear strength of the material) of randomly generated forces.

U.S. Patent Publication No. 20140290441 describes a one-way freewheel clutch type wrench, more specifically to an indicator mechanism for providing audible and/or tactile feedback when a one-way freewheel clutch wrench rotated in the unrestricted, or “reloading,” direction. The indicator mechanism has a ratchet wheel with teeth attached to a one-way freewheel clutch socket which interacts with at least one indicator located in a pocket of the box-end of the wrench.

U.S. Patent Publication No. 20150135908 describes a ratchet wrench that comprises a handle defining a cavity including a plurality of teeth on an inner periphery thereof, a wheel, a biasing spring ring, and at least one tooth pawl mounted in recesses formed on the outer periphery of the wheel. The wheel is rotatably mounted inside the cavity and the pawls are biased by the spring ring to engage the plurality of teeth on the inner periphery of the cavity when rotated in a first direction, and to slide over the plurality of teeth on the inner periphery of the cavity when rotated in a direction opposite the first direction.

U.S. Pat. No. 6,044,944 describes a force transfer device that includes an inner race and an outer race and a plurality of reversible wedging elements located between the inner and outer races. The device allows for continuous force transfer between the inner and outer race, and further allows for locking the inner race relative to the outer race in infinitely varying positions. The device includes scallops on at least one race, which scallops are of complex shapes in order to manage wedging of the wedging elements and surface stresses between the wedging elements and the race contact surfaces. The device is also reversible.

While each of the above-referenced devices generally work for intended purposes, conventional ratchet wrenches such as regular box wrenches, non-reversible and switchable ratchets use fixed internal geometries to engage with fasteners. In order to place a wrench end over the fastener, an initial clearance between wrench opening and fastener is required. Such clearance may worsen over time due to initial manufacturing tolerances, and rust and/or wear of the fastener and wrench. Resultant increased gap widths between the fastener and wrench opening may lead to user frustrations with fastener edges rounding under applied torque, and associated undesirable slippage of the wrench over the fastener. In addition, widening gaps between fastener and wrench openings can prevent removal of compromised (e.g., rounded/rusted) hardware. These limitations of current devices restrict effective use of current wrenches on rounded fasteners and/or in different environments. Therefore, there exists a need for a hand tool that offers improvement over existing ratchet wrenches.

### SUMMARY

In a principal aspect, the present disclosure relates to a tool that can operate act as a normal tool under traditional load conditions, and yet can operate on fasteners of different structural configurations (e.g., different shapes and sizes), including fasteners that are damaged and/or weakened from environmental conditions or user conditions.

In accordance with one or more exemplary embodiments of the present disclosure, a hand tool having an elongated handle, includes a cylindrical housing at one end. The housing includes a cavity that defines an annular wall within which a radially flexible C-shaped drive gear is rotatably supported. The drive gear has an outer periphery and an inner periphery, the inner periphery being configured to engage a fastener head. A cage member, also supported in the cavity, envelopes the drive gear and supports a plurality of roller members. The outer periphery of the drive gear contains circumferentially spaced pockets, and one roller is contained in each pocket. The bottom of each pocket defines a ramp that is angled radially toward the annular wall. When the hand tool is applied to a fastener, rotation of the handle causes the drive gear to bias the roller members, and to wedge them between the ramps and the annular wall. The drive gear is thereby compressed radially inwardly against the fastener head to apply a torque force on the fastener.

In accordance with another exemplary embodiment of the present disclosure, there is a ratchet wrench that is made of a handle and a cylindrical housing on one end of the handle. A flexible drive gear, such as a substantially C-shaped drive gear with fastener engaging geometry on an interior surface, has one or more pockets with ramps and/or recesses situated on its external or outer periphery. Rollers and/or pawls may be placed between the cylindrical housing and the drive gear. The ratchet wrench may also include a flexible cage member adapted to cover the gear and/or roller members. There may also be a washer member having a plurality of ridges or teeth on at least one surface configured to engage with at least one of the flexible gear and flexible cage member. Once the ratchet wrench is placed over the fastener, an initial torque may be applied to the handle to bias the roller members and/or pawls over the ramps on the substantially C-shaped drive gear. Movement of roller members over the ramps may compress the C-shaped gear radially inwardly from the cylindrical housing, closing the gap between gear and fastener, eliminating slipping and allowing compromised hardware removal. Further application of the torque on the handle may further wedge the roller members between the cylindrically shaped housing and the gear ramps, further compressing the drive gear and enabling an even greater torque on the fastener.

In accordance with another exemplary embodiment of the disclosure, a flexible wrench comprises a handle having an end defining a cavity, a substantially C-shaped drive gear wheel rotatably mounted in the cavity of the handle, a socket adapted to engage a fastener, a plurality of biasing elements mounted on a plurality of recesses on a surface of the drive gear. The gear may include a plurality of recesses configured to move the biasing elements against the gear to urge the roller members against the inner periphery of the cavity for the socket to engage a fastener.

In accordance with another exemplary embodiment, a wrench comprises a handle having an end defining a cavity and a plurality of teeth formed circumferentially on an inner periphery of the cavity, a C-shaped gear wheel rotatably mounted in the cavity of the handle, a plurality of biasing elements mounted in a plurality of recesses on a surface of the gear wheel, a flexible cage member configured to overlap the gear wheel and to interact with the biasing elements, a washer member configured to haptically interact with the flexible cage member, and wherein the gear includes a plurality of recesses configured to move a plurality of the biasing elements to urge the roller members against the inner periphery of the cavity of the handle, and the gear wheel to engage a fastener.

One aspect of the present disclosure provides a tool that can operate or act as a normal tool under traditional conditions, yet may operate on rounded fasteners that have been damaged, stripped, or altered from the fastener's original shape or condition.

Another aspect of the present disclosure includes a high friction wrench that can develop a high traction and/or friction against a fastener.

Another aspect of the present disclosure includes a high friction force that may be applied against a fastener by an internal geometry of a drive gear.

Another aspect of the present disclosure may prevent a fastener from becoming axially dislodged from an open end of a ratchet wrench.

Another aspect of the present disclosure includes a tool that has a structure that may resist slipping with increasing torque while maintaining substantial interference between a damaged fastener and the faces of the operative end of a tool.

Accordingly, it is a principal aspect of the disclosure to provide a novel tool that can translate torque onto a surface of a fastener under adverse conditions, irrespective of the hardness, shape, or condition of the fastener.

The terminology used herein is for describing particular embodiments only and is not intended to be limiting of the disclosure. As used herein, the singular forms, “a”, “an” and “the” are intended to include the plural forms as well, unless the context clearly indicates otherwise. It will be further understood that terms such as “include” and/or “have,” when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features, but may include other features not expressly listed or inherent to such process, method, article, or apparatus.

For definitional purposes and as used herein, “connected” or “attached” includes physical or electrical, whether direct or indirect, affixed or adjustably mounted. Thus, unless specified, “connected” or “attached” is intended to embrace any operationally functional connection.

As used herein, “substantially,” “generally,” “slightly” and other words of degree are relative modifiers intended to indicate permissible variation from the characteristic so modified. Such terms are not intended to be limited to their absolute values or the characteristics which they modify, but rather are intended to describe only in general terms any physical or functional attributes of the objects being described.

In the following disclosure, reference is made to accompanying drawings provided for descriptive and illustrative purposes, only. Such drawings reflect specific exemplary embodiments by which the disclosure may be practiced. Given the following description of the specification and drawings, the apparatus, methods, and systems should readily become understood and/or apparent to a person of ordinary skill in the art. Further areas of applicability of the present teachings will become apparent from the description and illustrations provided herein. It is to be understood that other embodiments may be utilized and that structural changes based on presently known structural and/or functional equivalents can be made without departing from the scope of the disclosure.

### DRAWINGS

The various advantages of one or more exemplary embodiments will become apparent to one skilled in the art upon reading the following specification and appended claims, and by referencing the following drawings, in which:

FIG. 1 illustrates a top, perspective view of an exemplary first embodiment of a hand tool constructed in accordance with this disclosure.

FIG. 2 illustrates an exploded view of the hand tool of FIG. 1.

FIG. 3 illustrates a perspective view of a drive gear of a drive gear assembly for the hand tool of FIG. 1.

FIG. 4 illustrates a top, cross-sectional view of the drive gear of FIG. 3.

FIG. 5 illustrates a perspective view of a cylindrical housing of the handle for the hand tool of FIG. 1.

FIG. 6 illustrates a perspective view of the drive gear assembly for the hand tool of FIG. 1.

FIG. 7 illustrates a bottom view of the drive gear assembly of FIG. 6 in a seated position in the cylindrical housing of FIG. 5.

FIG. 8 illustrates a top, perspective view of an exemplary second embodiment of a hand tool constructed in accordance with this disclosure.

FIG. 9 illustrates an exploded view of the hand tool of FIG. 8.

FIG. 10 illustrates a perspective view of a drive gear assembly for the hand tool of FIG. 8.

FIG. 11 illustrates a top, perspective view of a third exemplary embodiment of a hand tool constructed in accordance with this disclosure.

FIG. 12 illustrates an exploded view of the hand tool of FIG. 11.

FIG. 13 illustrates a top, perspective view of a drive gear assembly for the hand tool of FIG. 11.

FIG. 14 illustrates a top, perspective view of an exemplary fourth embodiment of a hand tool constructed in accordance with this disclosure.

FIG. 15 illustrates an exploded view of the hand tool of FIG. 14.

FIG. 16 illustrates a top, perspective view of a bifurcated cage member of a drive gear assembly for the hand tool of FIG. 14.

FIG. 17 illustrates a top, perspective view of an exemplary fifth embodiment of a hand tool constructed in accordance with this disclosure.

FIG. 18 illustrates an exploded view of the hand tool of FIG. 17.

FIG. 19 illustrates a sectional view of a drive gear assembly in a seated position in a cylindrical housing of the hand tool of FIG. 17.

FIG. 20 illustrates a perspective view of an exemplary embodiment of a spring ring that may be employed in one or more of the hand tools of this disclosure.

FIG. 21 illustrates a perspective view of another exemplary embodiment of a spring ring that may be employed in one or more of the hand tool of this disclosure.

FIG. 22 illustrates a top, perspective view of an exemplary embodiment of a haptic spring that may be employed in one or more of the hand tools of this disclosure.

FIG. 23 illustrates a bottom, perspective view of an exemplary embodiment of a haptic spring that may be employed in one or more of the hand tools of this disclosure.

FIG. 24 illustrates a top, perspective view of a bifurcated cage member of a drive gear assembly for the hand tool of FIG. 14.

FIG. 25 illustrates a bottom, perspective view of the haptic spring cage assembly of FIG. 23 in a seated position on the cage assembly of FIG. 24.

FIG. 26 illustrates a bottom, perspective view of the haptic spring cage assembly of FIG. 23 in a seated position on a spring ring of a drive gear assembly that may be employed in one or more of the hand tools of this disclosure.

FIG. 27 illustrates a top view of a drive gear assembly in a seated position in an exemplary embodiment of a cylindrical housing having circumferentially disposed teeth.

The illustrated images indicate corresponding elements and/or components that may be utilized in practice of the present disclosure. They illustrate only embodiments of the present disclosure, and are not to be construed in any manner as limiting the breadth or scope of any of the appended claims.

The described exemplary embodiments, aspects and features contained in the disclosure will become fully apparent upon review of the following description and drawings.

### DESCRIPTION

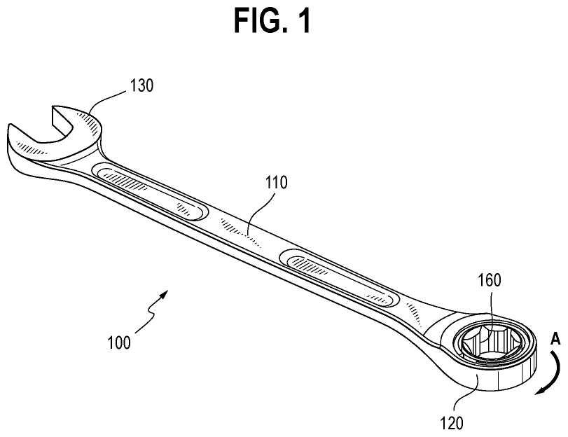

Turning to the figures, FIG. 1 illustrates an exemplary first embodiment of a hand tool 100 constructed in accordance with this disclosure. Although the illustrated exemplary embodiments demonstrate several iterations of a hand tool, the described embodiments are not limited thereto. This disclosure contemplates any suitable hand tool that may fall within the spirit, scope, and principles of this disclosure.

Moreover, the hand tool 100 may comprise one or more operational elements. Some of the possible operational elements of the hand tool 100 are illustrated in the figures described herein. It will be understood that it is not necessary for the hand tool 100 to incorporate all the elements illustrated in the figures set forth, and/or described herein. The hand tool 100 may have any combination of the various elements illustrated. Moreover, the hand tool 100 may have operational elements in addition to those illustrated in the figures.

As illustrated in FIG. 1, the exemplary hand tool 100 includes an elongated handle 110, with a cylindrical housing 120 at one end. An open-ended box wrench 130 may be optionally situated at an opposite end of the handle 110 to provide additional functionality. The hand tool may be operable as a ratchet wrench, as will be fully appreciated upon full reference to this disclosure.

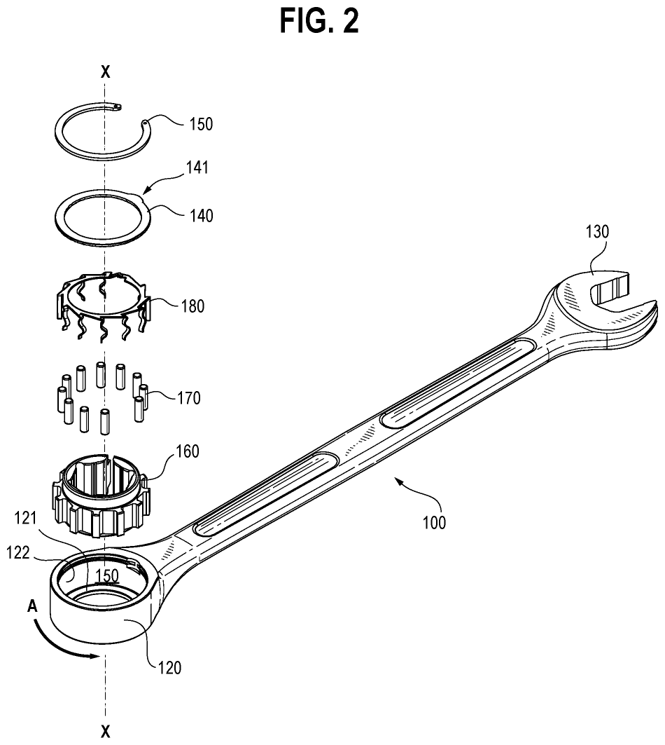

Referring also to FIG. 2, the cylindrical housing 120 includes a cavity 122 which contains an interior annular wall 150 that defines an axis X-X. In FIG. 2, the components of the drive gear assembly are shown assembled in the cylindrical housing 120, while being torqued along a circumferential arc A. A radially flexible drive gear 160 of a drive gear assembly is contained and rotatably supported inside of the cavity 122. In an assembled position inside the cavity 122, the drive gear assembly rests on an integral ledge 121 at a lower region of the housing 120, which at least partially covers and maintains the drive gear assembly at one end of the housing 120. Although the drive gear 160 may be described generally as being formed of an elastic material, such as a resiliently compressible material, embodiments are not limited thereto. This disclosure contemplates forming the drive gear 160 of any suitable material(s) that optimizes or otherwise transforms the performance and functionality of the one or more exemplary embodiments in a manner that falls within the spirit and scope of the principles of this disclosure. Such materials may include, but are not limited to, alloy steels, in addition to resilient composite materials that meet desired torque requirements.

At an opposite axial extremity (i.e., an upper region of the housing 120, as depicted), a washer member 140 and a snap ring 150 are operable to maintain or otherwise secure the drive gear assembly. In the illustrated exemplary embodiment, the drive gear 160 is formed as a substantially C-shaped member. Embodiments, however, are not limited thereto. This disclosure contemplates forming the drive gear 160 of any configuration that optimizes or otherwise transforms the performance and functionality of the one or more exemplary embodiments in a manner that falls within the spirit and scope of the principles of this disclosure.

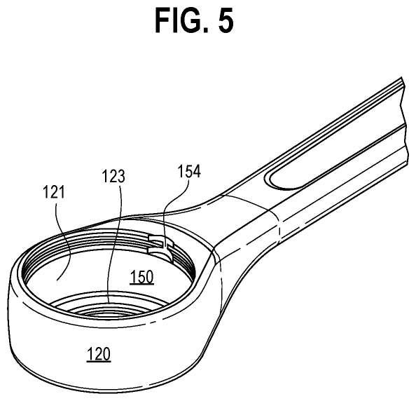

As illustrated in FIG. 5, a detent or notch 154 is arranged at an upper region of the wall 150 to serve as a rotation prevention feature. The notch 154 is oriented so as to interact with or otherwise engage a radial projection 141 on the washer member 140 to prevent undesirable rotation of the washer member 140 as the hand tool 100 is in the process of torquing and/or untorquing a fastener. The notch 154 may be integrally fabricated with the housing 120, or may be a separate component secured to the housing 120 via a welding connection, mechanical fastener, etc.

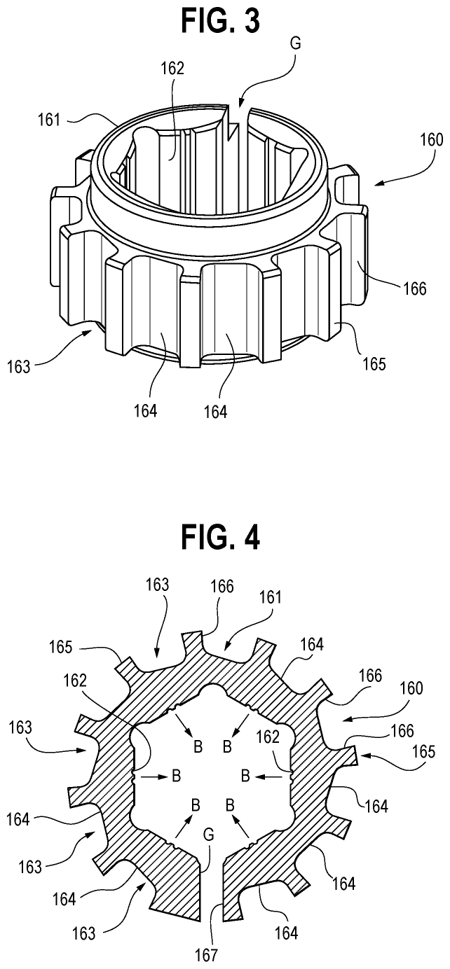

Referring also to FIGS. 3 and 4, the drive gear 160 has a circumferentially extending outer periphery 161, and a corresponding circumferentially extending inner periphery 162. The inner periphery 162 is configured to operate as a socket to engage a mechanical fastener (e.g., bolt, nut, etc.) in a manner that facilitates the fastening and/or removal of the fastener when the drive gear end of the hand tool 100 is applied to such fastener. Spaced ends 167 of the drive gear 160 define a gap G.

Referring now specifically to FIGS. 2 to 4, the outer periphery 161 of the drive gear 160 includes a plurality of circumferentially and uniformly spaced pockets 163 configured to contain a plurality of roller members 170. This disclosure contemplates forming the pocket 163 in any spatial arrangement that optimizes or otherwise transforms the performance and functionality of the one or more exemplary embodiments in a manner that falls within the spirit and scope of the principles of this disclosure. For example, the pockets 163 may be non-uniformly spaced or otherwise randomly spaced to meet a specific performance objective. Each pocket 163 contains one circumferentially extending ramp 164 which supports the movement of one roller member 170 during torquing and/or untorquing of a fastener by the hand tool 100 to achieve the fastening and/or removal of the fastener. As such, each ramp 164 is bordered by two of a plurality of radially extending protrusions 165. Each protrusion 165 acts as an abutment for limiting movement of the roller members 170, and thus, each protrusion 165 defines a pair of walls 166. Any given facing pair of walls 166 situated between adjacent protrusions 165 define circumferential extremities of each ramp 164.

Each ramp 164 is angularly oriented toward the annular wall 150 at a predefined angle. The predefined angle may fall within a range of 3-5°. Embodiments, however, are not limited thereto. This disclosure contemplates the predefined angle falling within any range that optimizes or otherwise transforms the performance and functionality of the one or more exemplary embodiments in a manner that falls within the spirit and scope of the principles of this disclosure. As such, each ramp 164 extends slightly radially outwardly from the circumferential outer periphery 161. Thus, when the drive gear end of the hand tool 100 is applied to a fastener, and the handle 110 is rotated in a first or torquing direction, i.e., see the circumferentially oriented arrow A (FIG. 1), the drive gear 160 will act to bias the roller members 170, which in turn will force the roller members 170 to wedge between the ramps 164 and the annular wall 150.

This action will resiliently compress the drive gear 160 radially inwardly against the fastener (see arrows B of FIG. 4) to thereby apply a torquing force on the fastener. Selective application of the torquing force also reduces the gap G as the inner periphery 162 of the drive gear 160 is radially squeezed against the fastener. The described gap reduction aspect in a compressed state of the drive gear 160 enables the hand tool 100 to accommodate a wider range of fastener sizes than might otherwise be achieved. Those skilled in the art may appreciate that the hand tool 100 may be axially flipped to reverse its functions on any given fastener. As such, torque may be reversibly applied to either install or to remove a fastener. Moreover, such physical compression of the drive gear 160 will enable the hand tool 100 to be employed effectively on compromised or rounded fasteners that may have become damaged, stripped, and/or otherwise altered from their original conditions.

On the other hand, when the handle 110 is selectively rotated in a reverse or opposite direction, i.e., a second non-torquing direction, the drive gear 160 will become decompressed, and thereby expand radially outwardly to relieve or otherwise release the torquing force on the fastener. As a result, the roller members 170 are dislodged from their wedged positions between the ramps 164 and the annular wall 150, and the formerly reduced gap G returns to a substantially untorqued position.

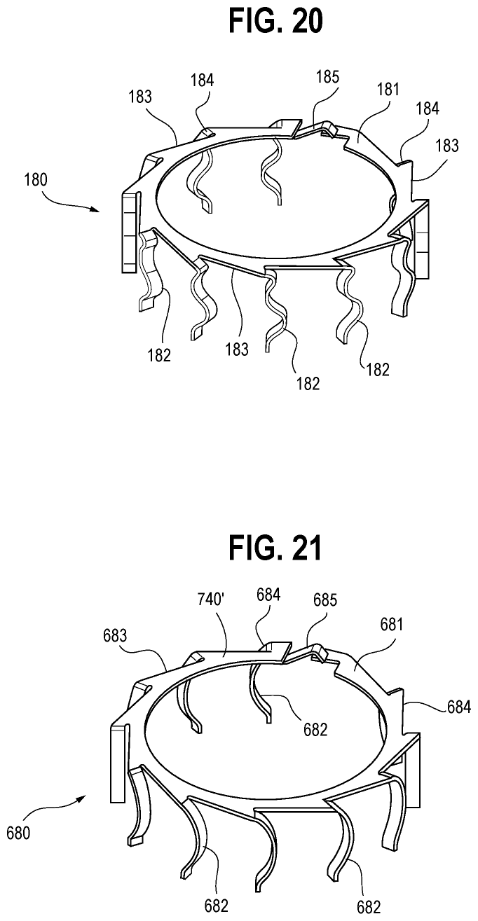

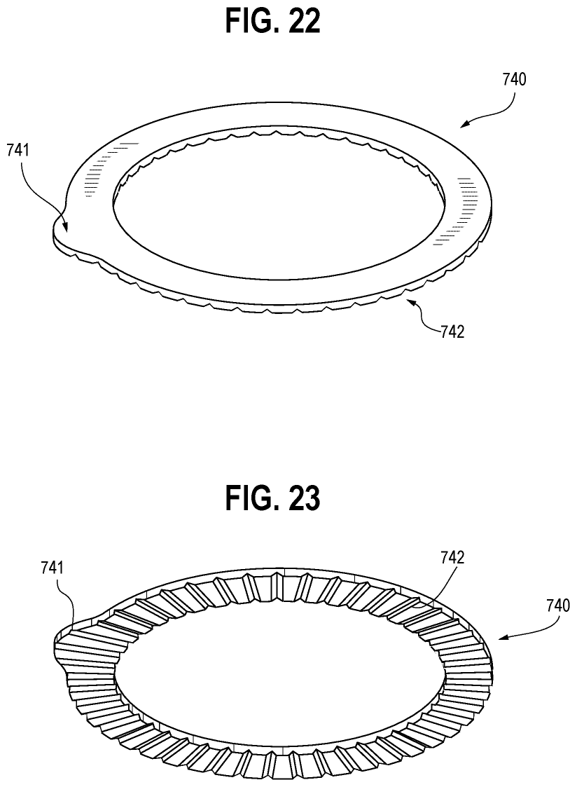

As illustrated in FIGS. 2 and 20, a spring ring member 180 has a general ring body 181 as a unitary body structure that can be readily formed from stamping an annular blank of a spring steel alloy to form a plurality of spring legs 182 from the ring body 181. Embodiments, however, are not limited thereto. This disclosure contemplates forming the spring ring member 180 of any material that optimizes or otherwise transforms the performance and functionality of the one or more exemplary embodiments in a manner that falls within the spirit and scope of the principles of this disclosure. As depicted, the ring body 181 has radial edges 183 from which the spring legs 182 may be formed by such a stamping operation, for example. An elbow 184 defines resultant resilient attachment points to the ring body 181. In the illustrated exemplary embodiment, the spring legs 182 are formed having an S-shaped profile or cross-section. Embodiments, however, are not limited thereto. This disclosure contemplates forming the spring legs 182 of any configuration that optimizes or otherwise transforms the performance and functionality of the one or more exemplary embodiments in a manner that falls within the spirit and scope of the principles of this disclosure.

Referring now also to FIG. 21, another embodiment of a unitary spring ring member 680 has a plurality of spring legs 682 that have a substantially C-shaped profile or cross-section. Embodiments, however, are not limited thereto. This disclosure contemplates forming the spring legs 682 of any configuration that optimizes or otherwise transforms the performance and functionality of the one or more exemplary embodiments in a manner that falls within the spirit and scope of the principles of this disclosure. The spring ring member 680 has a general ring body 681 as a unitary body structure that can be readily formed from stamping an annular blank of a spring steel alloy to form the spring legs 682 from the ring body 681. Embodiments, however, are not limited thereto. This disclosure contemplates forming the spring ring member 680 of any material that optimizes or otherwise transforms the performance and functionality of the one or more exemplary embodiments in a manner that falls within the spirit and scope of the principles of this disclosure. As depicted, the ring body 681 has radial edges 683 from which the spring legs 682 may be formed by such a stamping operation, for example. An elbow 684 defines resultant resilient attachment points to the ring body 681.

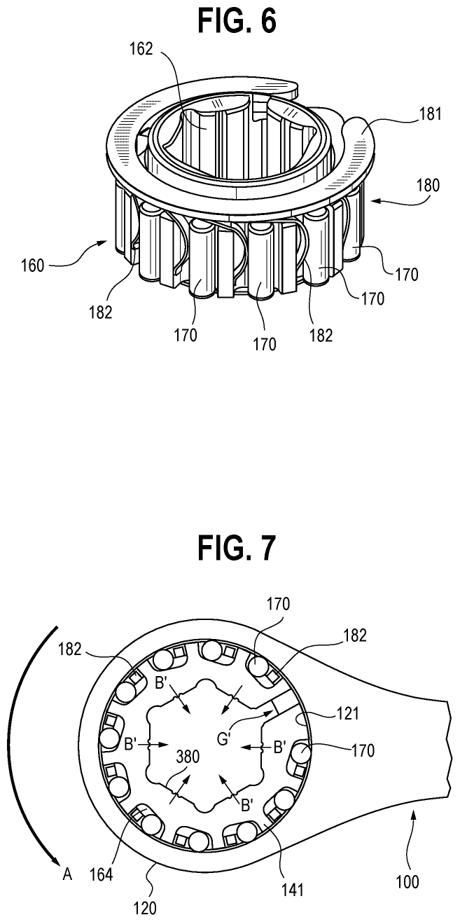

Referring now to FIG. 6, components of the drive gear assembly are illustrated, and include the drive gear 160, roller members 170, and the spring ring member 180 which are operable to apply a preload bias to the roller members 170 and thereby urge the roller members 170 to move along the angled ramps 164. The roller members 170 are thus forced against the annular wall 122, as herein previously described for torquing a fastener via compression of the inner periphery 162 of the drive gear 160 about the fastener. In the illustrated embodiment, each spring leg member 182 may be supported on a wall 166 (FIG. 4) of the drive gear 160, as contrasted with the differently configured preload bias members (described herein), which were supported on the walls of a cage member.

FIG. 7 provides an operational illustration of the elements described with respect to FIG. 6. In FIG. 7, the components of the drive gear assembly are shown assembled in the cylindrical housing 120, while being torqued along a circumferential arc A. The spring leg members 182 are shown urging the roller members 170 along the angled ramps 164, thus radially inwardly compressing (see arrow B′) the drive gear 160 such that the gap G is reduced as the inner periphery 162 of the drive gear 160 is radially squeezed against a fastener (not shown). The described gap reduction aspect in a compressed drive gear 160 will enable any particular hand tool 100 to accommodate a wider range of fastener sizes than might otherwise be achieved.

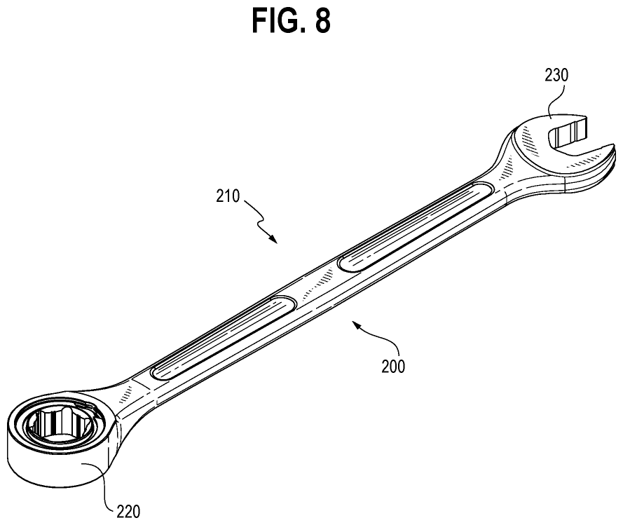

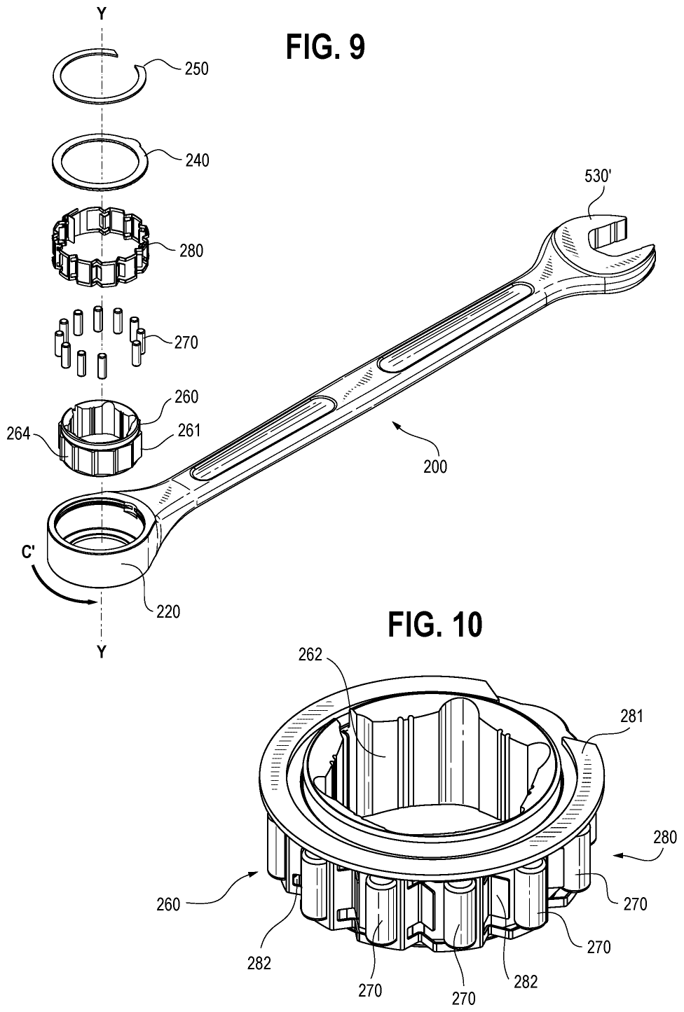

Turning to the figures, FIGS. 8 and 9 illustrate an exemplary second embodiment of a hand tool 200 constructed in accordance with this disclosure. Although the illustrated exemplary embodiments demonstrate several iterations of a hand tool, the described embodiments are not limited thereto. This disclosure contemplates any suitable hand tool that may fall within the spirit, scope, and principles of this disclosure.

Moreover, the hand tool 200 may comprise one or more operational elements set forth herein. Some of the possible operational elements of the hand tool 200 are illustrated in the figures described herein. It will be understood that it is not necessary for the hand tool 200 to incorporate all the elements illustrated in the figures set forth, and/or described herein. The hand tool 200 may have any combination of the various elements illustrated. Moreover, the hand tool 200 may have operational elements in addition to those illustrated in the figures.

As illustrated in FIG. 8, the exemplary hand tool 200 includes an elongated handle 210, with a cylindrical housing 220 at one end. An open-ended box wrench 230 may be optionally situated at an opposite end of the handle 210 to provide additional functionality. The hand tool 200 may be operable as a ratchet wrench, as will be fully appreciated upon full reference to this disclosure.

For sake of brevity, the cylindrical housing 220 incorporates the structural and functional architecture set forth in the cylindrical housing 120 of the hand tool 100 set forth of FIG. 1, and thus, will not be described here.

At an upper region of the housing 220, as depicted, a washer member 240 and a snap ring 250 are operable to maintain or otherwise secure the drive gear assembly in the housing 220.

In the illustrated exemplary embodiment, the drive gear 260 has a different structural configuration when compared to the drive gear 160 of FIG. 1. The drive gear 260 does not include a plurality of radially extending protrusions to maintain the roller members 270 in position. The outer periphery 261 of the drive gear 260 includes a plurality of circumferentially and uniformly spaced ramps 264, each of which supports the movement of one roller member 270 during torquing and/or untorquing of a fastener by the hand tool 200 to achieve the fastening and/or removal of the fastener. This disclosure contemplates forming the ramps 264 in any spatial arrangement that optimizes or otherwise transforms the performance and functionality of the one or more exemplary embodiments in a manner that falls within the spirit and scope of the principles of this disclosure. For example, the ramps 264 may be non-uniformly spaced or otherwise randomly spaced to meet a specific performance objective.

A flexible metal cage member 280 is supported in the cavity of the housing 220, and envelopes the drive gear 260 to support the roller members 270 for movement along the ramps 264. The metal cage member 280 is configured to be secured over the drive gear 260.

Although the metal cage member 280 may be described generally as being formed of a metal material, such as a sheet metal material, embodiments are not limited thereto. This disclosure contemplates forming the cage member 280 of any suitable material(s) that optimizes or otherwise transforms the performance and functionality of the one or more exemplary embodiments in a manner that falls within the spirit and scope of the principles of this disclosure.

Referring now to FIG. 10, components of the drive gear assembly are illustrated, and include the drive gear 260, roller members 270, and the metal cage member 280.

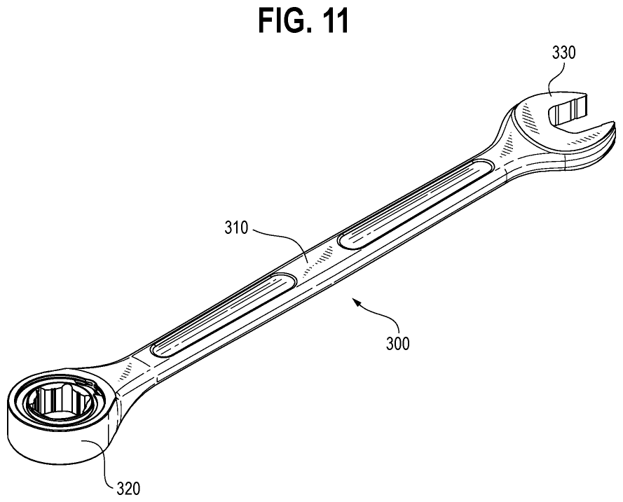

Turning to the figures, FIGS. 11 and 12 illustrate an exemplary third embodiment of a hand tool 300 constructed in accordance with this disclosure. Although the illustrated exemplary embodiments demonstrate several iterations of a hand tool, the described embodiments are not limited thereto. This disclosure contemplates any suitable hand tool that may fall within the spirit, scope, and principles of this disclosure.

Moreover, the hand tool 300 may comprise one or more operational elements set forth herein. Some of the possible operational elements of the hand tool 300 are illustrated in the figures described herein. It will be understood that it is not necessary for the hand tool 300 to incorporate all the elements illustrated in the figures set forth, and/or described herein. The hand tool 300 may have any combination of the various elements illustrated. Moreover, the hand tool 300 may have operational elements in addition to those illustrated in the figures.

As illustrated in FIG. 11, the exemplary hand tool 300 includes an elongated handle 310, with a cylindrical housing 320 at one end. An open-ended box wrench 330 may be optionally situated at an opposite end of the handle 210 to provide additional functionality. The hand tool 300 may be operable as a ratchet wrench, as will be fully appreciated upon full reference to this disclosure.

For sake of brevity, the cylindrical housing 320 incorporates the structural and functional architecture set forth in the cylindrical housings 120, 220 of the hand tools 100, 200 set forth herein, and thus, will not be described here.

At an upper region of the housing 320, as depicted, a washer member 340 and a snap ring 350 are operable to maintain or otherwise secure the drive gear assembly in the housing 320.

In the illustrated exemplary embodiment, the drive gear 360 has the same structural configuration of the drive gear 260 of FIG. 8. Thus, the drive gear 360 does not include a plurality of radially extending protrusions to maintain the roller members 370 in position. The outer periphery 361 of the drive gear 360 includes a plurality of circumferentially and uniformly spaced ramps 364 which supports the movement of one roller member 370 during torquing and/or untorquing of a fastener by the hand tool 300 to achieve the fastening and/or removal of the fastener. This disclosure contemplates forming the ramps 364 in any spatial arrangement that optimizes or otherwise transforms the performance and functionality of the one or more exemplary embodiments in a manner that falls within the spirit and scope of the principles of this disclosure. For example, the ramps 364 may be non-uniformly spaced or otherwise randomly spaced to meet a specific performance objective.

A flexible plastic cage member 380 is supported in the cavity of the housing 320, and envelopes the drive gear 360 to support the roller members 370 for movement along the ramps 364. The plastic cage member 380 is configured to be secured over the drive gear 360.

Although the plastic cage member 380 may be described generally as being formed of a plastic material, such as a polymer material, embodiments are not limited thereto. This disclosure contemplates forming the cage member 380 of any suitable material(s) that optimizes or otherwise transforms the performance and functionality of the one or more exemplary embodiments in a manner that falls within the spirit and scope of the principles of this disclosure.

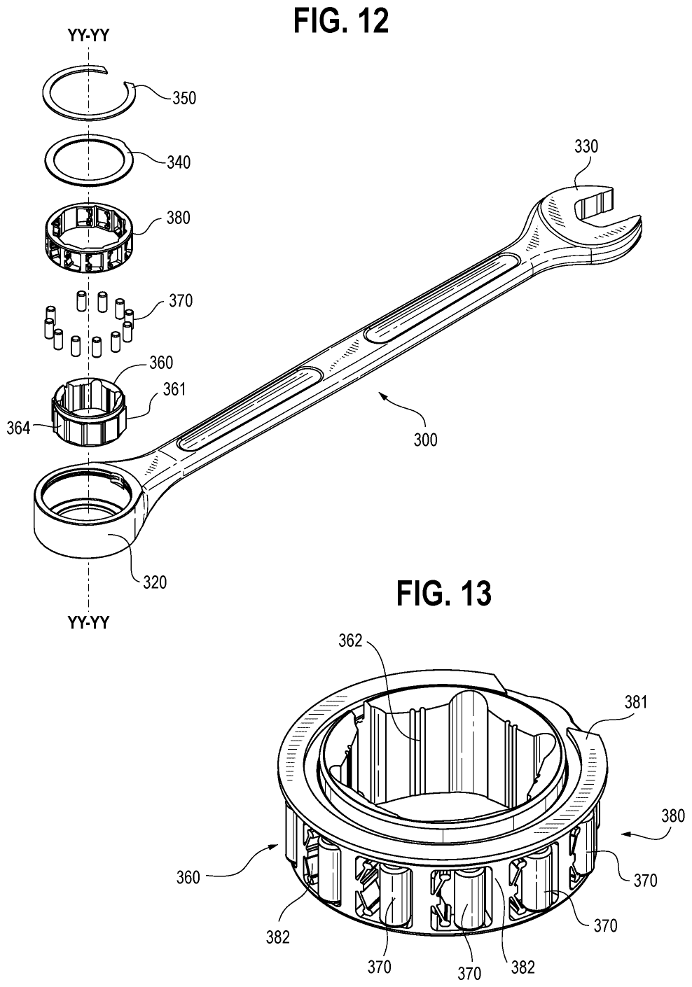

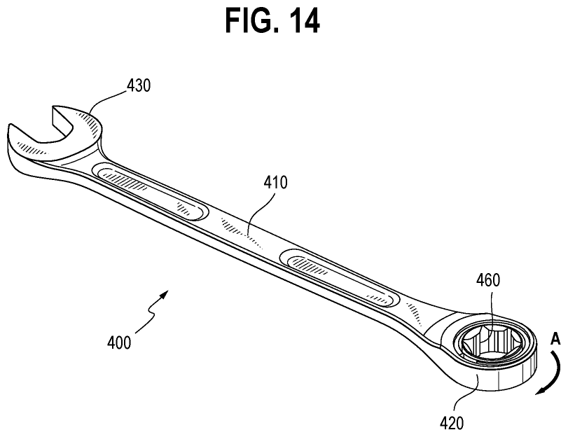

Referring now to FIG. 13, components of the drive gear assembly are illustrated, and include the drive gear 360, roller members 370, and the plastic cage member 380.

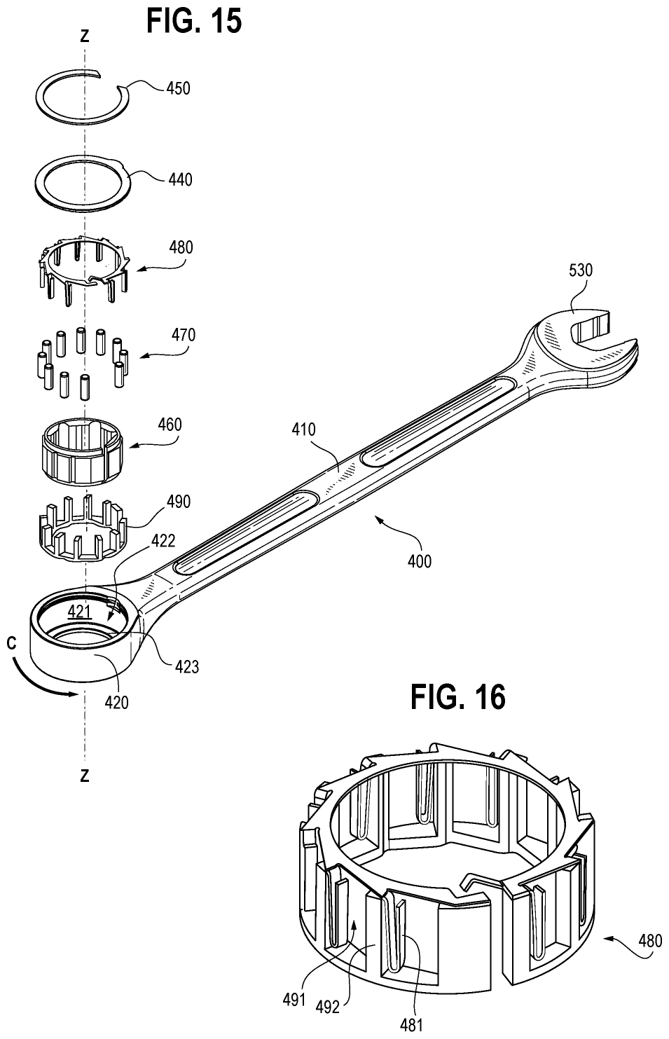

Turning to the figures, FIGS. 15 and 16 illustrate an exemplary fourth embodiment of a hand tool 400 constructed in accordance with this disclosure. Although the illustrated exemplary embodiments demonstrate several iterations of a hand tool, the described embodiments are not limited thereto. This disclosure contemplates any suitable hand tool that may fall within the spirit, scope, and principles of this disclosure.

Moreover, the hand tool 400 may comprise one or more operational elements set forth herein. Some of the possible operational elements of the hand tool 400 are illustrated in the figures described herein. It will be understood that it is not necessary for the hand tool 400 to incorporate all the elements illustrated in the figures set forth, and/or described herein. The hand tool 400 may have any combination of the various elements illustrated. Moreover, the hand tool 400 may have operational elements in addition to those illustrated in the figures.

As illustrated in FIG. 15, the exemplary hand tool 400 includes an elongated handle 410, with a cylindrical housing 420 at one end. An open-ended box wrench 430 may be optionally situated at an opposite end of the handle 410 to provide additional functionality. The hand tool 400 may be operable as a ratchet wrench, as will be fully appreciated upon full reference to this disclosure.

In an assembled position inside the cavity 422, the drive gear assembly rests on an integral ledge 421 at a lower region of the housing 420, which at least partially covers and maintains the drive gear assembly at one end of the housing 420. At an opposite axial extremity (i.e., an upper region of the housing 420, as depicted), a washer member 440 and a snap ring 450 are operable to maintain or otherwise secure the drive gear assembly.

As illustrated in FIG. 16, a bifurcated cage member includes an upper cage member 480 and a lower cage member 490 that are axially interleaved (FIG. 16) with each other within the cavity 422 of the housing 420 to support movement of the roller members 470 about the drive gear 460. In an assembled state, the bifurcated cage member is configured to be secured over the drive gear 460. The bifurcated cage member includes apertures 491 defined by adjacent walls 492. Each wall 492 supports a hair-pin shaped preload bias member 481 of the upper cage member 480. The preload bias member 481 comprises a spring for urging the roller members 470 against the annular wall 422 during torquing of a fastener.

Turning to the figures, FIGS. 17 through 19 illustrate an exemplary fifth embodiment of a hand tool 500 constructed in accordance with this disclosure. Although the illustrated exemplary embodiments demonstrate several iterations of a hand tool, the described embodiments are not limited thereto. This disclosure contemplates any suitable hand tool that may fall within the spirit, scope, and principles of this disclosure.

Moreover, the hand tool 500 may comprise one or more operational elements set forth herein. Some of the possible operational elements of the hand tool 500 are illustrated in the figures described herein. It will be understood that it is not necessary for the hand tool 500 to incorporate all the elements illustrated in the figures set forth, and/or described herein. The hand tool 500 may have any combination of the various elements illustrated. Moreover, the hand tool 500 may have operational elements in addition to those illustrated in the figures. The operative components, i.e., the drive gear 560 and the roller members 570, are shown in an exploded array along an axis Y-Y. The several remaining components situated along the axis Y-Y are for securing the operative components in the housing cavity 522. The latter include, as depicted, a lower retainer ring 580, a lower snap ring 550, and an upper snap ring 540, each cooperatively working to secure the operative components in the housing 520 for functions as described herein, and as may be fully appreciated by those skilled in the art.

The drive gear 560 has a circumferentially extending outer periphery 561, and a corresponding circumferentially extending inner periphery 562. The inner periphery 562 is configured to operate as a socket to engage a mechanical fastener (e.g., bolt, nut, etc.) in a manner that facilitates the fastening and/or removal of the fastener when the drive gear end of the hand tool 500 is applied to such fastener. Spaced ends 567 of the drive gear 560 define a gap.

The outer periphery 561 of the drive gear 560 and the inner interior annular wall 522 of the housing 520 define a plurality of circumferentially and uniformly spaced pockets configured to contain the roller members 570. This disclosure contemplates forming the pockets in any spatial arrangement that optimizes or otherwise transforms the performance and functionality of the one or more exemplary embodiments in a manner that falls within the spirit and scope of the principles of this disclosure. For example, the pockets may be non-uniformly spaced or otherwise randomly spaced to meet a specific performance objective. Each pocket contains a circumferentially extending ramp 564 which supports the movement of one roller member 570 during torquing and/or untorquing of a fastener by the hand tool 500 to achieve the fastening and/or removal of the fastener.

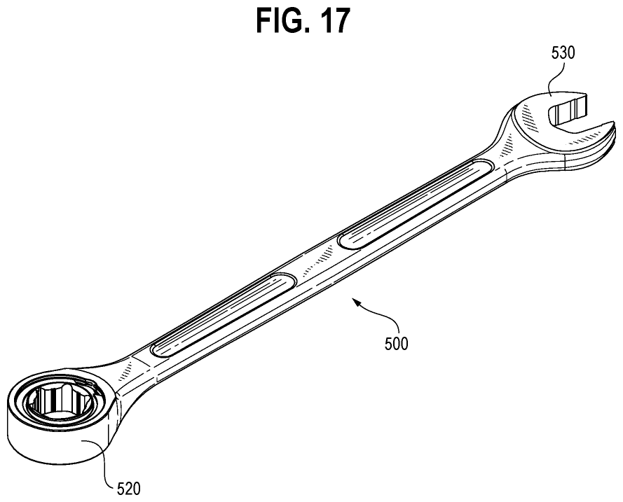

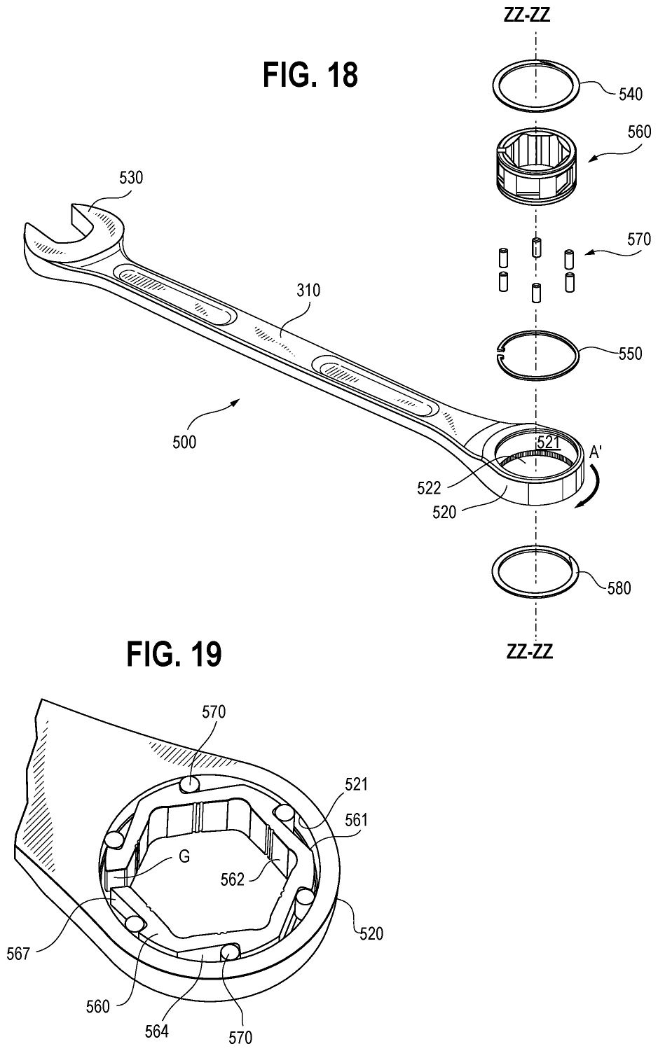

Each ramp 564 is angularly oriented toward the annular wall 550 at a predefined angle. The predefined angle may fall within a range of 3-5°. Embodiments, however, are not limited thereto. This disclosure contemplates the predefined angle falling within any range that optimizes or otherwise transforms the performance and functionality of the one or more exemplary embodiments in a manner that falls within the spirit and scope of the principles of this disclosure. As such, each ramp 564 extends slightly radially outwardly from the circumferential outer periphery 561. Thus, when the drive gear end of the hand tool 500 is applied to a fastener, and the handle 510 is rotated in a first or torquing direction, i.e., see the circumferentially oriented arrow A (FIG. 18), the drive gear 560 will act to bias the roller members 570, which in turn will force the roller members 570 to wedge between the ramps 564 and the annular wall 550.

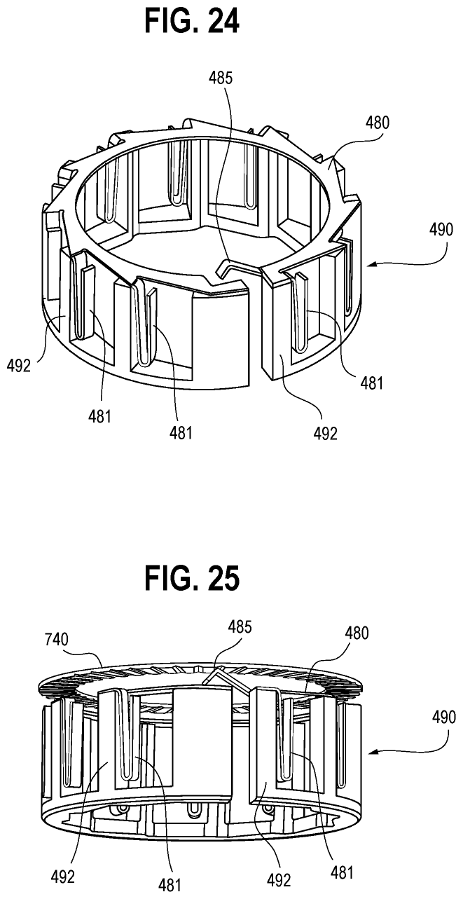

Referring now to FIGS. 24 through 27, a ratchet feature may be incorporated into one or more of the hand tools 100, 200, 300, 400, and 500, as now described.

A washer member 740 is operable to interact with or otherwise engage the cage members to produce a haptic feedback and/or audible feedback mechanism in response to selective rotation of the handle of in a specific direction, i.e., whenever the handle is rotated in an unloaded or untorqued condition. For this purpose, the washer 740 may include a plurality of radially extending teeth 742 on its lower surface, as depicted in FIG. 23. During selective rotation of the handle, the teeth 742 are operable to interact or otherwise engage with a spring tab member 485 to produce haptic feedback and/or audible feedback, as depicted in FIG. 25. The spring tab member 485 may be formed as an integral member of the upper cage member 480, as for example by a machine stamping process that enables formation of the upper cage member 480. In the configuration illustrated, the spring tab member 485 extends axially from the radially extending ring body of the upper cage member 480.

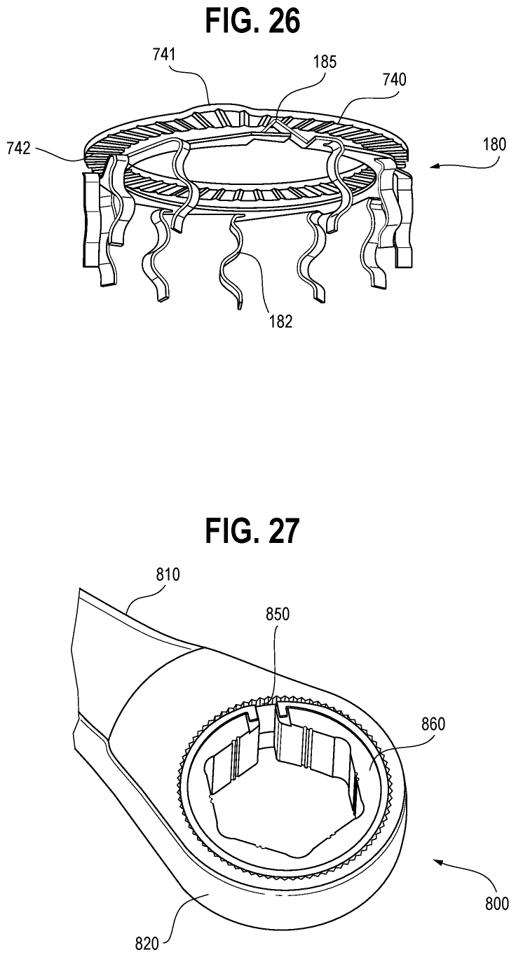

Referring now to FIG. 25, the interaction of the spring tab member 485 with the teeth 742 of the washer 740 may be better appreciated. In FIG. 25, the washer 740 is also shown interacting or engaging with the spring tab 485 of the upper cage member 480. FIG. 26 shows such an interaction or engagement between the spring tab member 185 of FIG. 20 with the teeth 742. It may be further noted that the washer 740 also includes a radial projection 741 which may act as a rotation prevention feature in similar fashion to that of the radial projection previously described herein.

Other embodiments of haptic feedback and audible feedback mechanisms may also be provided in the various hand tool embodiments described herein. Thus, for example, referring to FIG. 27, another embodiment of a hand tool 800 is shown having a plurality of circumferentially disposed teeth 850 within its cylindrical housing 820. In the hand tool 800, interaction with roller members (not shown) may provide another way to achieve haptic feedback and/or audible feedback, which would be configured to occur with rotation of the handle 810 in an unloaded or untorqued condition.

Those skilled in the art will appreciate from the foregoing description that broadly described aspects of the embodiments of the present disclosure may be implemented in a variety of forms. Therefore, while the embodiments of this disclosure have been described in connection with particular examples, the true scope of the embodiments of the disclosure should not be construed as limited. In addition, other modifications will become apparent to the skilled practitioner upon a study of the drawings and specification.

What is claimed is:

1. A hand tool, comprising:
an elongated handle having an interior annular wall that defines a cavity;
an elastically flexible drive gear rotatably supported in the cavity for movement between a radially compressed position and a radially decompressed position, the drive gear having an inner periphery configured to engage a fastener, and an outer periphery containing circumferentially spaced pockets;
a plurality of roller members, each roller member moveably contained in a corresponding pocket of the drive gear; and
a cage member to support the drive gear in the cavity to facilitate movement of the roller members that causes movement of the drive gear to the radially compressed position to apply a torquing force on the fastener in response to selective rotation of the handle in a first direction.

2. The hand tool of claim 1, wherein each pocket comprises a ramp oriented toward the annular wall, and a pair of radial protrusions defining circumferential boundaries of each ramp, the protrusions defining walls for limiting circumferential movement of each roller member.

3. The hand tool of claim 2, wherein each wall is biased against a corresponding roller member to force the roller member to wedge between the ramp and the annular wall and thereby radially compress the inner periphery of the drive gear inwardly against the fastener to apply the torquing force on the fastener.

4. The hand tool of claim 1, wherein the drive gear is caused, in response to selective rotation of the handle in a second direction that is opposite to the first direction, to move to the radially decompressed position release the torquing force on the fastener.

5. The hand tool of claim 4, wherein the drive gear is caused to expand radially outward in response to the selective rotation of the handle in the second direction to dislodge the roller members from wedged positions between the ramps and the annular wall.

6. The hand tool of claim 1, wherein the drive gear is formed of a resiliently compressible material.

7. The hand tool of claim 6, wherein the resilient material comprises an alloy steel.

8. A hand tool, comprising:
an elongated handle having an interior annular wall that defines a cavity;
an elastically flexible drive gear configured to engage a fastener, the drive gear being rotatably supported in the cavity for movement between a radially compressed position to apply a torquing force on the fastener, and a radially decompressed position to relieve the torquing force on the fastener; and
a plurality of roller members moveably contained on the drive gear; and
a plurality of abutments on the drive gear that, in response to selective rotation of the handle in a first direction, facilitate movement of the roller members that causes movement of the drive gear to the radially compressed position.

9. The hand tool of claim 8, wherein the drive gear comprises an inner periphery configured to engage the fastener, and an outer periphery containing circumferentially space ramps, and the plurality of abutments positioned between the circumferentially spaced ramps, and the ramps being oriented toward the annular wall.

10. The hand tool of claim 9, wherein each roller member is supported on a corresponding ramp for movement along the ramp between a corresponding abutment and the annular wall.

11. The hand tool of claim 10, wherein each abutment is biased against a corresponding roller member to force the roller member to wedge between the ramp and the annular wall and thereby radially compress the drive gear inwardly against the fastener to apply the torquing force on the fastener.

12. The hand tool of claim 11, wherein each abutment defines one circumferential boundary of one ramp.

13. The hand tool of claim 12, wherein each abutment limits movement of the corresponding roller member.

14. The hand tool of claim 8, wherein the drive gear is formed of a resiliently compressible material.

15. The hand tool of claim 14, wherein the resilient material comprises an alloy steel.

16. A hand tool, comprising:
an elongated handle having an interior annular wall that defines a cavity;
an elastically flexible drive gear having an inner periphery operable to engage a fastener and an outer periphery containing circumferentially spaced abutments and circumferentially spaced ramps oriented toward the annular wall, the drive gear being rotatably supported in the cavity for movement between a radially compressed position to apply a torquing force on the fastener, and a radially decompressed position to relieve the torquing force on the fastener;
a plurality of roller members supported on the ramps for movement between the abutments and the annular wall; and
a bias member arranged between a corresponding abutment and a corresponding roller member to apply a bias force that urges the roller member against the annular wall in response to the selective rotation of the handle in the torquing direction.

17. The hand tool of claim 16, wherein the drive gear expands radially outwardly in response to the selective rotation of the handle in the non-torquing direction to facilitate dislodging of the rollers from wedged positions between the ramps and the annular wall.

18. The hand tool of claim 16, further comprising a washer member supported in the cavity, the washer member having a radial projection on an outer edge thereof that engages a notch in the annular wall to prevent rotation of the washer member during selective rotation of the handle.

19. The hand tool of claim 16, wherein the drive gear is formed of a resiliently compressible material.

20. The hand tool of claim 19, wherein the resilient material comprises an alloy steel.
